(19) United States
(12) Patent Application Publication
(10) Pub. No.: US 2005/0269410 A1
(43) Pub. Date: Dec. 8, 2005

(54) Authentication of optical cards

(75) Inventor: Kevin Wilson, Denver, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BSI2000, Inc., Lakewood, CO (US)

(21) Appl. No.: 11/145,549

(22) Filed: Jun. 3, 2005

Related U.S. Application Data
(60) Provisional application No. 60/577,111, filed on Jun. 4, 2004.

(51) Int. Cl. G06K 7/10; G06K 7/14

(52) U.S. Cl. 235/454

(57) ABSTRACT

An optical card is authenticated. The optical card has data stored on tracks in an optical storage area At least some of the data are encrypted. A character string is read optically from one of the tracks without decrypting any of the encrypted data. The character string is stored as a sequence of etched and unetched states within the track. The character string read from the track is verified to be identical to a predefined authentication string.

### CROSS-REFERENCES TO RELATED APPLICATIONS

This application is a nonprovisional of, and claims the benefit of the filing date of, U.S. Prov. Pat. Appl. No. 60/577,111, entitled “OPTICAL-CARD PROTOCOL,” filed Jun. 4, 2004 by Kevin Wilson, the entire disclosure of which is incorporated herein by reference for all purposes.

### BACKGROUND OF THE INVENTION

This application relates generally to optical cards. More specifically, this application relates to methods and systems for authenticating optical cards.

The development of optical cards has been relatively recent. They are cards that are typically made to be about the size of a standard credit card and which store digitized information in an optical storage area. The information written to the optical storage area is generally written according to a standards protocol that is intended, among other things, to mitigate the possibility of certain types of errors that may result from the physical layout of information in the storage area.

The information encoded in the optical storage area often includes information that identifies a holder of the card, and as such optical cards are expected to become widely used as identification instruments. Such uses may be implemented by both private and public organizations, and, indeed, a number of government authorities have already begun to issue optical cards for use as national identity cards, as immigration cards, and the like. The information stored in this optical storage area is often encrypted so that it can only be extracted by using a suitable decryption algorithm. While it is often possible to verify the authenticity of an optical card by decrypting the information and analyzing it, such procedures are relatively costly, and require making the decryption algorithm available to a party responsible for performing the authentication, with a resultant decrease in control over accessibility of the algorithm.

There is accordingly a general need in the art for authentication mechanisms for optical cards that avoid some of these issues.

### BRIEF SUMMARY OF THE INVENTION

Embodiments of the invention thus provide methods and systems for authenticating an optical card. The optical card has data stored on a plurality of tracks comprised by an optical storage area of the optical card. At least some of the data are encrypted. A character string is read optically from one of the plurality of tracks without decrypting any of the encrypted data. The character string is stored as a sequence of etched and unetched states within the one of the plurality of tracks. The character string read from the one of the plurality of tracks is verified to be identical to a predefined authentication string.

The one of the plurality of tracks may be a read-only track. In some embodiments, the one of the plurality of tracks is disposed physically at an end of the optical storage area. In some instances, the one of the plurality of tracks is a second read-only track; in such instances, the character string may be read optically from the one of the plurality of tracks in response to previously failing to verify that a first read-only track contains the predefined authentication string. The first read-only track may be disposed physically at one end of the optical storage area and the second read-only track disposed physically at another end of the optical storage area. In one embodiment, the optical storage area is searched to identify the second read-only track.

In response to verifying that the character string read from the one of the plurality of tracks is identical to the predefined authentication string, a notification may be issued that the optical card is authentic.

Methods of the invention may be embodied in an authentication device for authenticating an optical card. An optical card reader is adapted to optically read sequences of etched and unetched states within the plurality of tracks on the optical card. A processor is provided in communication with the optical-card reader and has programming instructions to implement methods of the invention.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIGS. 1A-1C provide schematic illustrations of different forms of optical cards that may be used in embodiments of the invention;

FIG. 2 provides a schematic illustration of an optical-card authentication device in an embodiment of the invention;

FIG. 3 provides a schematic illustration of a processing system that may be used by the optical-card authentication device of FIG. 2; and

FIG. 4 is a flow diagram illustrating methods for generating and authentication optical cards in embodiments of the invention.

### DETAILED DESCRIPTION OF THE INVENTION

Embodiments of the invention authenticate optical cards by verifying the presence of an unencrypted authentication string on the optical card. In addition to having encrypted information that may have characteristics specific to the purpose of a given optical card, such an unencrypted authentication string is also present in embodiments of the invention. Because this authentication string is not encrypted, it may be read from the optical card without needing to apply the decryption algorithm needed to read the other information from the optical storage area of the card. Authentication of the optical card may thus be performed by a wide range of authentication authorities who perform an intermediate function of verifying the authenticity of a particular optical card without actually using the optical card.

There are numerous applications for such intermediate functions. Merely by way of example, consider the issuance of an immigration card by a governmental authority, such as the issuance of a resident alien card by the United States to permanent residents of the United States in the form of optical cards. When such permanent residents travel outside the United States, they may be required to present their resident alien card to a U.S. immigration official to regain entry to the United States. With generally heightened concern throughout the world for possible terrorist activity, an authentication device may be disposed at airports throughout the world that have airlines flying directly from other countries to the United States. The authentication device may be used to verify that passengers on flights to the United States that purport to be permanent residents at least possess an authentic resident alien card. Such possession may be imposed as a requirement to board the flight, with final decisions regarding entry being made at the U.S. destination by an immigration official having access to decryption software that reads the specific information encoded on the optical card. Other examples of intermediate authentication functions of this type will be evident to those of skill in the art.

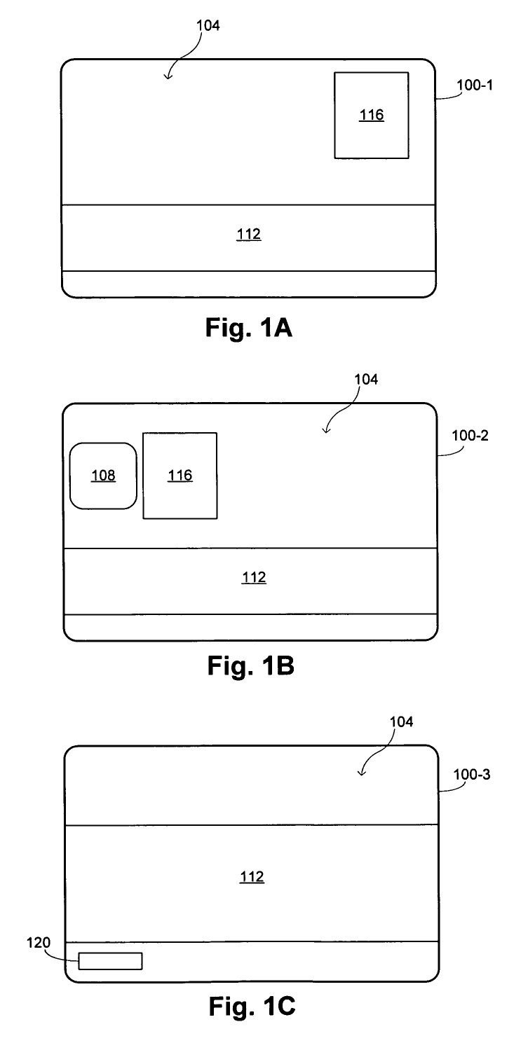

Embodiments of the invention may be implemented with a variety of optical-card designs, some of which are illustrated in FIGS. 1A-1C. Such optical cards may be of the specific type described in U.S. Pat. No. 5,979,772, entitled “OPTICAL CARD” by Jiro Takei et al., the entire disclosure of which is incorporated herein by reference for all purposes, but more generally include any card that uses optical storage techniques. Such optical cards are typically capable of storing very large amounts of data in comparison with magnetic-stripe or smart cards. For example, a typical optical card may compactly store up to 4 Mbyte of data, equivalent to about 1500 pages of typewritten information. As such, optical cards hold on the order of 1000 times the amount of information as a typical smart card. Unlike smart cards, optical cards are also impervious to electromagnetic fields, including static electricity, and they are not damaged by normal bending and flexing.

Many optical cards use a technology similar to the one used for compact discs (“CDs”) or for CD ROMs. For example, a panel of gold-colored laser-sensitive material may be laminated on the card and used to store the information. The material comprises several layers that react when a laser light is directed at them. The laser etches a small hole, about 2 μm in diameter, in the material; the hole can be sensed by a low-power laser during a read cycle. The presence or absence of the etch spot defines a binary state that is used to encode data. In some embodiments, the data can be encoded in a linear x-y format described in detail in the ISO/IEC 11693 and 11694 standards, the entire contents of which are incorporated herein by reference for all purposes.

FIG. 1A provides a diagram that illustrates a structure for an optical card in one embodiment. The card 100-1 includes a cardholder photograph 116, an optical storage area 112, and a printed area 104 on one side of the card. The other side of the card could include other features, such as a bar code(s) or other optically recognizable code, a signature block, a magnetic stripe, counterfeiting safeguards, and the like. The printed area 104 could include any type of information, such as information identifying the cardholder so that, in combination with the photograph 116, it acts as a useful aid in authenticating a cardholder's identity. The printed area 104 could also include information identifying the issuer of the card, and the like. The optical storage area 112 holds digitized information, and may comprise a plurality of individual sections that may be designated individually by an addressing system.

Another embodiment of an optical card 100-2 is illustrated in FIG. 1B. This embodiment adds electronics 108 to the optical card 100-2 to provide smart-card capabilities. The electronics 108 may be interfaced with contacts on the surface of the card 100-2. The electronics could include a microprocessor, nonvolatile memory, volatile memory, a cryptographic processor, a random-number generator, and/or any other electronic circuits. Unlike the optical storage area 112, information stored in the electronics 108 is not discernible without destroying the card 100-2. Electronic security measures could be used to protect reading information stored in the electronics 108.

A further embodiment of an optical banking card 100-3 is shown in FIG. 1C. To illustrate that different embodiments may accommodate different sizes of optical storage areas, this embodiment uses a larger optical storage area 112 than the embodiments of FIGS. 1A or 1B. In addition, a radio-frequency identification (“RFID”) tag 120 that can be read by proximity readers may be included.

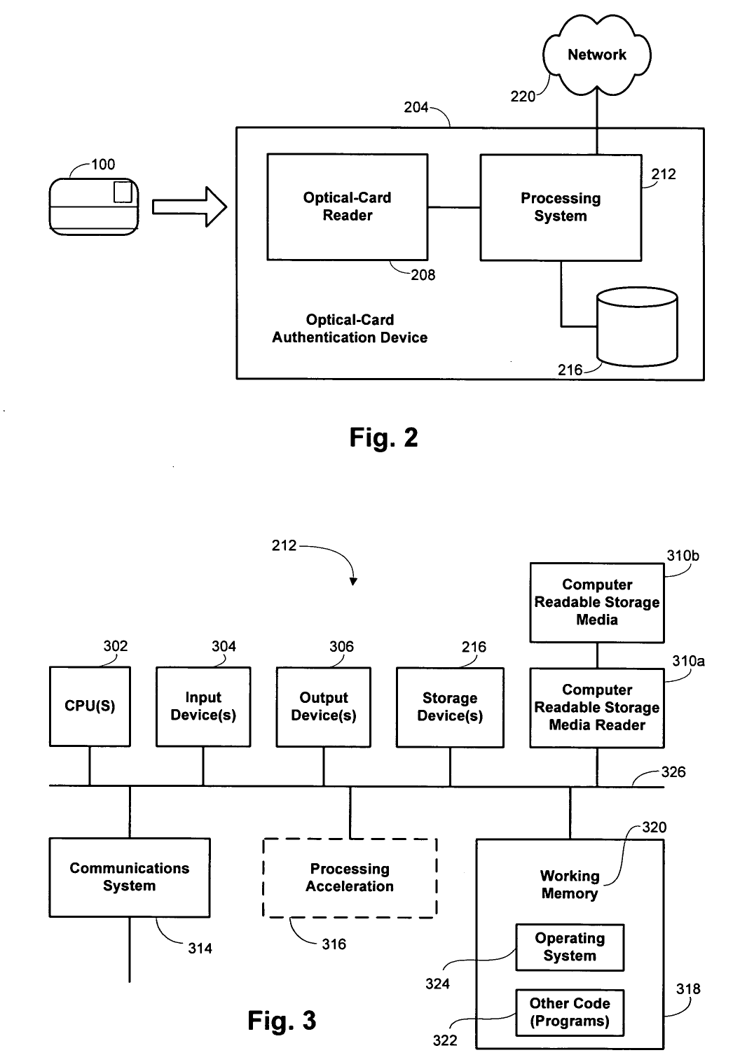

FIG. 2 illustrates one structure that may be used for an optical-card authentication device 204 designed to detect and verify the presence of an unencrypted authentication string on a presented optical card 100. The authentication device 204 comprises an optical-card reader 208, which may be any of a variety of different types, examples of which include portions of the optical-card processing unit described in commonly assigned U.S. Pat. No. 6,775,774, entitled “OPTICAL CARD BASED SYSTEM FOR INDIVIDUALIZED TRACKING AND RECORD KEEPING,” or in commonly assigned U.S. patent application Ser. No. 10/726,971, entitled “OPTICAL CARD BASED SYSTEM FOR INDIVIDUALIZED TRACKING AND RECORD KEEPING,” or include portions of the optical-card reader described in U.S. patent application Ser. No. 11/122,784, entitled “AUTHENTICATING OPTICAL-CARD READER,” which is a nonprovisional of U.S. Prov. Pat. Appl. No. 60/568,407, entitled “AUTHENTICATION OPTICAL CARD READER.” The entire disclosure of each of the preceding patents and applications is incorporated herein by reference for all purposes. The optical-card reader 208 generally includes structure for illuminating the optical storage area of the optical card 100 and has optical structure that allows a sequence of bit patterns to be detected.

The optical-card reader 208 is provided in communication with a processing system 212 that may include or be coupled with a data store 216. The processing system includes software programming that may be used in coordinating operation of the optical-card reader 208 and in evaluating the bit patterns that are detected by the optical-card reader 208. For example, the authentication string that must be matched for the optical card to be identified as authentic may be stored in the data store 216 as a bit pattern, with the processing system 212 having instructions to compare the bit pattern read from an unencrypted portion of the optical storage area. As described below, such instructions may require identifying the portion of the optical storage area that includes the unencrypted string.

The authentication device 204 may be one of a plurality of such devices, which may be interconnected through a network 220. The network may be a local-area network, a wide-area network, or a global network such as the Internet in different embodiments. Furthermore, the network 220 may be a private network or may be a public network, in which case it is generally expected that communications through the network 220 that involve the authentication device 204 will be encrypted. The network 220 may also provide access by the authentication device 204 to other sources of information, programming updates, etc.

The processing system 212 itself may comprise any suitable computational unit, one example of which is illustrated schematically in FIG. 3. This drawing broadly illustrates how individual system elements may be implemented in a separated or more integrated manner. The processing system 212 is shown comprised of hardware elements that are electrically coupled via bus 326, including a processor 302, an input device 304, an output device 306, a computer-readable storage media reader 310a, a communications system 314, a processing acceleration unit 316 such as a DSP or special-purpose processor, and a memory 318. In this example, the storage device 216 is shown integrated with the processing system 212 rather than as a separate device in communication with the processing system 212. The output device 306 may comprise a screen used to indicate to an authentication official whether a particular optical card 100 has or has not been authenticated by confirming the presence of the authentication string. Alternatively or in addition, the output device 306 may comprise a color-coded arrangement of lights used to indicate whether the optical card 100 has been authenticated. Other output devices 306 may include printers, magnetic-disk writers, optical-disk writers, etc., which may be used to generate archival records of cards that have been examined as well as other types of records. The computer-readable storage media reader 310a is further connected to a computer-readable storage medium 310b, the combination comprehensively representing remote, local, fixed, and/or removable storage devices plus storage media for temporarily and/or more permanently containing computer-readable information. The communications system 314 may comprise a wired, wireless, modem, and/or other type of interfacing connection and permits data to be exchanged with the network 220 as described above.

The processing system 212 also comprises software elements, shown as being currently located within working memory 320, including an operating system 324 and other code 322, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

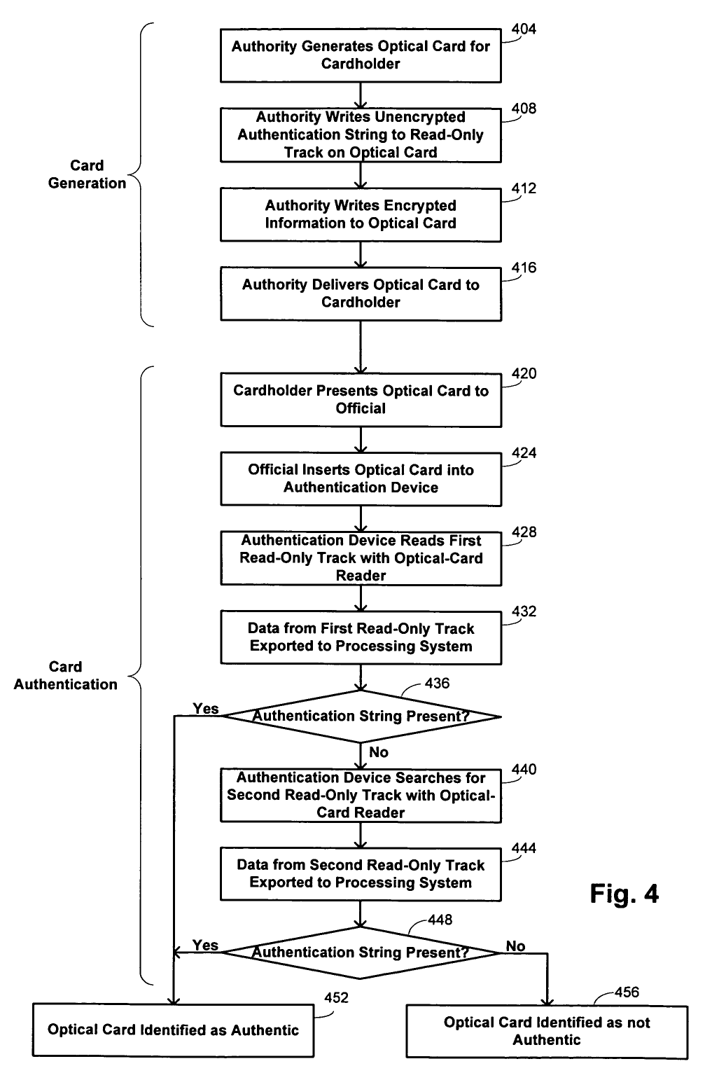

An overview of methods of the invention, both for the generation of optical cards that include the authentication string and for authentication of cards that are presented by a cardholder, is provided with the flow diagram of FIG. 4. In discussing this flow diagram below, specific reference is sometimes made to the optical-card protocol set forth in the ISO/IEC 11694-4 Specification, which has been incorporated by reference. This specific discussion is provided for exemplary purposes and is not intended to be limiting since other alternative optical-card protocols may be accommodated with other embodiments of the invention.

At block 404, an authority generates an optical card 100 for a cardholder. The authority may comprise a private authority or a public authority, such as a government agency, in different embodiments. The generation of the optical card 100 includes writing the unencrypted authentication string to the optical card at block 408 and writing of encrypted information in the optical storage area at block 412. As indicated in the drawing, in some embodiments, the authentication string is written to a read-only track of the optical card 100 at the time of generating the optical card. Other actions may be taken in generating the optical card initially, including affixing a photograph of the authorized cardholder, measuring and storing biometrics of the authorized cardholder, and the like. The prepared optical card is delivered to the authorized cardholder at block 416.

Merely by way of example, Appendix B.9 of the ISO/IEC 11694-4 Specification identifies two format description tracks that are to be created when the optical card is manufactured and to which optical-card drives are unable to write. A card is deemed to be invalid unless these format description tracks are present. One of the format description tracks is located at the top of the optical storage area and the other is located at the bottom of the optical storage area. These tracks consist of six sectors of 162 bytes each, corresponding to Sector Type 1 summarized in Table B.3 of the ISO/IEC 11694-4 Specification. Sectors 0, 2, and 4 contain a data format and card manufacturing information, while sectors 1, 3, and 5 contain an error message to be returned in the event of improper use of the card. The data format of sectors 0, 2, and 4 is summarized in the following table, which corresponds to Table B.1 of the ISO/IEC 11694-4 Specification, using a nominal number of 2583 data tracks:

| Offset | Length | Description | Values | Values (hex) | Control |
|---|---|---|---|---|---|
| 0 | 2 | Data format identifier | 2 | 0002 | Std |
| 2 | 2 | Track pitch | 120 | 0078 | Std |
| 4 | 2 | Nominal number of data tracks | 2583 | 0A17 | Std |
| 6 | 2 | Usable track length | 6964 | 1B34 | Std |
| 8 | 2 | Type of preformat data | 1 | 0001 | Mfg |
| 10 | 2 | Data encoding identifier | 1 | 0001 | Std |
| 12 | 2 | Maximum sectors per track | 40 | 0028 | Std |
| 14 | 2 | Preformatted data bit size | 22 | 0016 | Std |
| 16 | 2 | Written data bit size | 22 | 0016 | Std |
| 18 | 2 | Written data pitch | 50 | 0032 | Std |
| 20 | 2 | Sector type identifier | 2 | 0002 | Std |
| 22 | 2 | EDAC scheme identifier | 1 | 0001 | Std |
| 24 | 2 | Media type identifier | 4 | 0004 | Mfg |
| 26 | 2 | Card type identifier | 1 | 0001 | Std |
| 28 | 2 | Manufacturing plant identifier | 1 | 0001 | Mfg |
| 30 | 4 | Master identifier | ISO | 49534F20 | Std |
| 34 | 6 | Serial number of master | 1 | 0001 | Mfg |
| 40 | 122 | Reserved for future use | | (set to zero) | Std |
| Total | 162 | | | | |
| bytes | | | | | |

Certain 4.1 MB optical cards (having a 2.86 MB user capacity) contain the authorization string at location 0×1E (hex notation). Other fields may include strings that may alternatively function as the authorization string in other embodiments. Another type of card having a 1.1 MB user capacity, which is sometimes referred to as a “hybrid card” because it is designed for use with a smart chip, may have similarly located authorization strings, although the specific characters of the strings may differ. Still other cards may contain different authentication strings located in different positions in accordance with other embodiments.

Some existing programming models require that data written to the card be written into “static files,” which can be rapidly read, or “partitioned files,” which require the information about the partition to be opened from the card before the file can be read. This extra action necessarily slows down the reading of the data from partitioned files. The model also requires that “static files” be declared (in number and in size) when the card is first formatted by the Application. Thus, writing and reading dynamic information (i.e. information that was not considered when the card was first made, but which could optionally be added to the card at a later time) to and from the card requires that this information reside in partitioned files, which are inherently slower to open than are static files. In alternative embodiments, the cards may be optimized for speed of reading using other file systems without such limitations, but with direct access to the track and sector data on the card.

Such a protocol thus permits accessing data (both read and write) on the card in a direct track and sector format, thus bypassing the concept of “static files” and “partitioned files.” Embodiments of the invention make use of a tool for examining an application (exe) or application extension (dll) and display the loaded dll's and their API calls for viewer examination. An exemplary tool is the “Dependency Walker” tool, which ships with Microsoft Visual C++ Version 6. Arguments for the partitioned call, e.g. track, sector, format, count, address of buffer to place read data, address of count of data read, etc. are believed to exist in such calls. The drive number used to initially open the partition may also replace the first argument in some calls.

The physical track 0 is one of the format description tracks described. Depending on the number of physical tracks present on the card, the other format description track may exist at physical track 2582 (Type B.6.1.1 as described in the ISO/IEC 11694-4 Specification) or 999 (Type B.6.2.1 and B.6.3.1 as described in the ISO/IEC 11694-4 Specification). These two arrangements correspond to the 4.1 MB (2.85 MB User Capacity) and the 1.1 MB User Capacity cards described above respectively.

With the optical card thus prepared for the cardholder, the cardholder may thereafter present the optical card to an authentication official at block 420. In embodiments of the invention, such an authentication official is generally concerned with verifying the authenticity of the optical card rather than with obtaining access to the encrypted portion of the optical storage area. The authentication official thus inserts the optical card 100 into the authentication device 204 at block 424 so that the authentication device may read the first read-only track with the optical-card reader 208 at block 428. As noted above for certain exemplary optical-card embodiments, this track may be track 0. The data from the first read-only track are exported to the processing system at block 432 so that a check may be made at block 436 whether the authentication string is present in the first read-only track. If so, the authentication device 204 identifies the optical card 100 as authentic at block 452.

If the authentication string is not detected at block 436, either because it is not present or because the first track has been damaged, the authentication device 204 searches for a second read-only track with the optical-card reader 212 at block 440. In an alternative embodiment, information provided in the standard API calls such as _LscReadCardFormat@8 followed by _LscGetDriveInfo@8 may be used. If identified, data from the second read-only track is exported to the processing system at block 444 so that a check may be made at block 448 whether the authentication string is present in that read-only track. If so, the authentication device 204 identifies the optical card as authentic at block 452.

This process may continue for as many read-only tracks as are present on the optical card 100. While the specific illustrations described above correspond to embodiments in which the expected number of read-only tracks is two, this is not a requirement of the invention and protocols may be accommodated that have a different number of read-only tracks. If the authentication string is not found in any of the read-only tracks, the authentication device 204 alerts the authentication official at block 456 that it was not possible to authenticate the optical card 100.

The information provided to the authentication official, i.e. whether the optical card 100 has been authenticated or not, permits the official to take appropriate action with respect to the cardholder. For example, if possession of an authenticated card was a requirement for boarding an airplane, the cardholder might be denied boarding if the authentication device 204 is unable to authenticate the card 100.

Thus, having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

1. A method for authenticating an optical card having data stored on a plurality of tracks comprised by an optical storage area of the optical card, at least some of the data being encrypted, the method comprising:
optically reading a character string from one of the plurality of tracks without decrypting any of the encrypted data, the character string being stored as a sequence of etched and unetched states within the one of the plurality of tracks; and
verifying that the character string read from the one of the plurality of tracks is identical to a predefined authentication string.

2. The method recited in claim 1 wherein the one of the plurality of tracks is a read-only track.

3. The method recited in claim 1 further comprising issuing a notification that the optical card is authentic in response to verifying that the character string read from the one of the plurality of tracks is identical to the predefined authentication string.

4. The method recited in claim 1 wherein:
the one of the plurality of tracks is a second read-only track; and
optically reading the character string from the one of the plurality of tracks is performed in response to previously failing to verify that a first read-only track contains the predefined authentication string.

5. The method recited in claim 4 wherein the first read-only track is disposed physically at one end of the optical storage area and the second read-only track is disposed physically at another end of the optical storage area.

6. The method recited in claim 4 further comprising searching the optical storage area to identify the second read-only track.

7. The method recited in claim 1 wherein the one of the plurality of tracks is disposed physically at an end of the optical storage area.

8. A method for authenticating an optical card having data stored on a plurality of tracks comprised by an optical storage area of the optical card, at least some of the data being encrypted, the method comprising:
identifying a first of the tracks as a first read-only track;
failing to optically read a character string from the first read-only track;
searching the optical storage are to identify a second read-only track distinct from the first read-only track;
optically reading the character string from the second read-only track, the character string being stored as a sequence of etched and unetched states within the second read-only track;
verifying that the character string read from the second read-only track is identical to a predefined authentication string; and
issuing a notification that the optical card is authentic in response to verifying that the character string read from the second read-only track is identical to the predefined authorization string,
wherein none of the encrypted data are decrypted prior to issuing the notification.

9. The method recited in claim 8 wherein the first and second read-only tracks are disposed physically at opposite ends of the optical storage area.

10. An authentication device for authenticating an optical card having data stored on a plurality of tracks comprised by an optical storage area of the optical card, at least some of the data being encrypted, the authentication device comprising:
an optical-card reader adapted to optically read sequences of etched and unetched states within the plurality of tracks; and
a processor in communication with the optical-card reader and having programming instructions to:
operate the optical-card reader to read a character string from one of the plurality of tracks without decrypting any of the encrypted data, the character string being stored as a sequence of etched and unetched states within the one of the plurality of tracks; and
verify that the character string read from the one of the plurality of tracks is identical to a predefined authentication string.

11. The authentication device recited in claim 10 wherein the one of the plurality of tracks is a read-only track.

12. The authentication device recited in claim 10 wherein the processor further has programming instructions to initiate issuing a notification that the optical card is authentic in response to verifying that the character string read from the one of the plurality of tracks is identical to the predefined authentication string.

13. The authentication device recited in claim 10 wherein:
the one of the plurality of tracks is a second read-only track; and
the instructions to operate the optical-card reader to read the character string from the one of the plurality of tracks are executed in response to previously failing to verify that a first read-only track contains the predefined authorization string.

14. The authentication device recited in claim 13 wherein the first read-only track is disposed physically at one end of the optical storage area and the second read-only track is disposed physically at another end of the optical storage area.

15. The authentication device recited in claim 13 wherein the processor further comprises instructions to operate the optical-card reader to search the optical storage area to identify the second read-only track.

16. The authentication device recited in claim 10 wherein the one of the plurality of tracks is disposed physically at an end of the optical storage area.
